(19) United States
(12) Patent Application Publication
(10) Pub. No.: US 2004/0223553 A1
(43) Pub. Date: Nov. 11, 2004

(54) Method and system for wireless audio transmission using low bit-weight words

(76) Inventor: Derek D. Kumar, San Jose, CA (US)

Correspondence Address: Joseph W. Berenato, III, Liniak, Berenato & White, LLC, Suite 240, 6550 Rock Spring Drive, Bethesda, MD, 20817, US

(21) Appl. No.: 10/772,408

(22) Filed: Feb. 6, 2004

Related U.S. Application Data
(60) Provisional application No. 60/445,458, filed on Feb. 7, 2003.

(51) Int. Cl. H04L 27/00

(52) U.S. Cl. 375/259

(57) ABSTRACT

A method and system for the wireless radio-frequency (RF) transmission and reception of an audio signal use a substantially oversampled and low bit-weight digital word representation. An analog electrical signal, representing acoustic audio information, is digitized with a high-precision delta-sigma modulator without corresponding decimating lowpass filter. The delta-sigma modulator output is a sequence of single bit words. Each bit is unweighted or equally weighted. The words are generated at a frequency that substantially exceeds the critical (Nyquist) sampling frequency, so that the signal is substantially oversampled. The oversampled and low bit-weight digital word representation minimizes the complexity and power consumption of analog-to-digital conversion, which facilitates mobile or portable use with long battery life. The corresponding digital decimating lowpass filter is implemented in the receiver system, when necessary.

### CROSS REFERENCE TO RELATED APPLICATIONS AND CLAIM TO PRIORITY

This application is a non-provisional application of prior U.S. provisional application Ser. No. 60/445,458, filed Feb. 2^{nd}, 2003, the disclosure of which is incorporated herein by reference and priority to which is claimed under 35 U.S.C. § 120.

### BACKGROUND OF THE INVENTION

1. Field of the Invention

The present invention relates to wireless microphones and related audio signal transmission and receiving systems.

2. Discussion of the Prior Art

Wireless microphones are transmitter and receiver systems that propagate a representation of an acoustic audio signal from an audio transducer (microphone) at one location to another location for remote reception by means of radio-frequency (RF) propagation. They are widely used in applications where a direct cable connection would be impractical, for example, in concert or broadcasting applications in which one or more singers or speakers is in motion. Different methods and systems for wireless microphone transmitters and receivers are known in the art. In certain systems, the microphone transducer signal is conveyed from the transmitter to a receiver by direct analog modulation of a radio-frequency (RF) carrier signal in the very high frequency (VHF) band, which is 30 megahertz (MHz) to 300 MHz, or the ultra high frequency (UHF) band, which is 300 MHz to 3000 MHz, using the analog frequency modulation (FM) method, similar to that used in commercial analog FM-band broadcasting. Prior art FIG. 1 is a block diagram representing a conventional FM RF wireless microphone transmitter system. Prior art FIG. 2 is a block diagram of a corresponding receiver system. See also U.S. Pat. No. 6,246,864 to Koike, issued Jun. 12, 2001. In FIG. 1, audio signal 10 is a sound pressure wave and is detected by microphone 20, generating an electrical (analog) signal. The analog signal is typically limited in bandwidth by the transducer or by the system implementation to less than about 20 kilohertz (kHz). The electrical (analog) signal is propagated to FM modulator 30. FM modulator 30 emits a frequency-modulated analog RF signal whose instantaneous frequency deviation is proportional to the amplitude of the analog audio signal. The RF signal is amplified in RF power amplifier 40 and coupled to transmitting antenna 50. Typically, FM modulator 30 is implemented with a voltage-controlled oscillator (VCO). With reference to the FIG. 2 FM receiver system, the emitted RF wave propagates through free space and is detected by receiving antenna 60 as an electrical (analog) RF signal. The analog RF signal is bandpass filtered (not shown), amplified 70 and propagated to FM demodulator 80. In some implementations (not shown), the analog RF signal is frequency-translated (shifted) to an intermediate frequency (IF) representation prior to subsequent demodulation. Frequency-translation does not change the fundamental FM demodulation method. FM demodulator 80 tracks the instantaneous frequency deviation of the received analog RF signal and generates an analog control signal that is proportional to the estimated instantaneous deviation (i.e. change in frequency from unmodulated carrier frequency). FM demodulator 80 may be implemented as a phase-locked loop (PLL) where the loop bandwidth is greater than the highest analog audio frequency. Since the instantaneous frequency deviation in the FM transmitter system is generated in such a way that it is proportional to the amplitude of the analog audio signal amplitude, the analog control signal determined by FM demodulator 80 is also proportional to the audio signal amplitude, in the absence of disturbances to the RF signal. The demodulated analog signal is lowpass filtered 90 to remove out-of-band noise generated during the FM demodulation process and is propagated as analog audio signal 100. In typical applications, the bandwidth of the modulated RF signal is less than about 200 kHz and the audio signal bandwidth is limited to about 20 kHz. There are several advantages to such systems, particularly in the mass consumer wireless microphone market. Analog FM modulator and demodulator circuits are physically small, inexpensive to manufacture, and consume relatively small amounts of power. Small physical size and low power consumption are especially important considerations when the transmitter system is to be worn by a speaker or singer. If the transmitter system requires frequent battery changes or requires a direct power mains connection, much of the advantage of having a wireless system is lost. However, a significant disadvantage of these systems is that the microphone transducer signal is an analog or continuous representation throughout the transmitter and receiver system. The RF signal environment is subject to deleterious effects from many sources of noise and interference. Under ideal testing conditions in laboratory settings, FM wireless microphone system receivers may achieve high signal to noise ratios (SNR), around 100 decibels (dB). However, in practical use RF environments, the achieved signal-to-noise ratio is much typically much lower, less than about 60 dB. Furthermore, the VHF and UHF radio frequency bands are subject to the deleterious effects of multipath interference, in which unintentional signal echoes from the transmitter reflect off of objects and structures in the propagation environment and distort the received RF signal. Analog FM demodulation methods are known to be sensitive to multipath interference. Thus, even small disturbances in the RF environment result in imperfect reconstruction of the audio signal at the receiver. This becomes especially important when the wireless microphone system is used in applications which require very high signal quality and fidelity (i.e., wide audio bandwidth, low phase and amplitude distortion, and low noise), for example, as used in audio production mastering for movies on film and digital media such as digital versatile disc (DVD), television, radio, and recordings. For high fidelity applications, it is preferable to have a digital audio representation of the microphone signal.

Devices that implement methods for representing analog audio signals as digital signals are widely used in both the professional and consumer audio markets. An early commercial success for digital audio methods was the compact-disc (CD) optical audio storage format, which was developed by Sony and Philips Corporation. In comparison and contrast to the continuous representation of an analog audio signal by, for example, analog FM modulation, in digital audio methods, the audio signal is represented by a time-evolving sequence of audio samples, each of which corresponds to one of a plurality of discrete (digital) levels. In the CD-format, an audio signal is represented as a sequence of digital words at a precise sampling (word) rate. In the consumer CD format, each word has a resolution of 16 bits and is sampled at 44.1 kHz. The 16-bit word format is known as pulse code modulation (PCM). Integrated circuit devices for the conversion of an analog audio signal, such as that from a microphone, to a digital audio signal with PCM word representation are readily available and are known as audio analog-to-digital converters (ADCs). High quality ADC's for audio applications with at least 16-bit PCM word length and sampling frequencies equal to or higher than that used in the CD format are inexpensive and widely available (see for example, the Texas Instruments PCM1801 integrated circuit ADC, which is a 16-bit 48 kHz sampling frequency stereo ADC, and the Cirrus Logic CS5396, which is a 24-bit 96 kHz stereo ADC).

A characteristic of the PCM format is that each bit position in the PCM word has a different (increasing) associated magnitude. Thus, PCM words are an example of a weighted number system. For example, in the CD-format, the 16th bit in each PCM word has a weight of 32,768 when compared to the 1st bit (least significant bit), which has a weight of 1, and the 2nd bit, which has a weight of 2. As a further example, an 8-bit twos-complement PCM word [b₇ b₆ b₅ b₄ b₃ b₂ b₁ b₀], where b₀, b₁, b₂, b₃, b₄, b₅, b₆, and b₇ are binary digits (0 or 1), and where b₀ is the least significant bit, represents an encoded analog signal amplitude given by the following formula:

$$PCM amplitude level = - {2}^{7} \cdot {b}_{7} + {2}^{6} \cdot {b}_{6} + {2}^{5} \cdot {b}_{5} + {2}^{4} \cdot {b}_{4} + \\ {2}^{3} \cdot {b}_{3} + {2}^{2} \cdot {b}_{2} + {2}^{1} \cdot {b}_{1} + {2}^{0} \cdot {b}_{0} \\ = - 128 \cdot {b}_{7} + 64 \cdot {b}_{6} + 32 \cdot {b}_{5} + 16 \cdot {b}_{4} + \\ 8 \cdot {b}_{3} + 4 \cdot {b}_{2} + 2 \cdot {b}_{1} + {b}_{0}$$

The symbol dot (·) in the above formula indicates multiplication. By inspection, the contribution of the weighted b₆ bit to the overall PCM amplitude (sum) is much larger, in other words, more significant and having larger weight, than the contribution of bit b₁, for example. As the number of bits in the PCM word is increased, the significance or weight difference between the 1 st bit and last bit in the word also increases exponentially. Next-generation audio systems such as the DVD-Audio format specify PCM word lengths of up to 24-bits, corresponding to a signal dynamic range of over 120 decibels. The dynamic range of such systems is beyond the capability of most transducers achievable with current technology, but the objective of such a high-resolution format is to have the fidelity limited by the physical characteristics of the transducers and not by the mathematical characteristics of the format itself. PCM systems with such wide word widths (i.e. high bit-weight difference between least and most significant bits) are, in general, very sensitive to bit errors because of the weighted representation, especially when errors occur in the highly weighted bits.

Wireless microphone systems that transmit and receive digital representations (i.e. PCM words) of a microphone signal instead of a continuous analog signal representation are known in the art. For example, the Sennheiser Digital 1000 Series uses a 16-bit ADC and a proprietary transmission method. However, a significant disadvantage of these systems is that ADCs with high resolution typically consume significant amounts of power. For example, the 24-bit 96 kHz Cirrus Logic 5396 integrated circuit stereo ADC integrated circuit consumes over 0.5 Watts per channel (over 1 Watt total), using over 100 milliamps (mA) per channel at 5V. In wireless microphone systems, the amount of power available is usually limited by the battery capacity. For example, a typical 9 Volt battery has a capacity of only about 450 milliamp hours (mAhr), so that the ADC integrated circuit alone would consume the total battery energy in only a few hours. Furthermore, it is desirable that a majority of the power consumed in the transmitter system be used in the generation of the RF signal for efficient propagation, subject to the restrictions for the desired RF band of operation as provided in the Rules and Regulations of the Federal Communications Commission (FCC) in the United States, or equivalent frequency spectrum regulatory authority elsewhere. Another disadvantage of using a conventional PCM ADC in the transmitter system with a high bit-weight word in a wireless microphone system is that the weighted representation may make it difficult to ensure that the PCM word is received error-free in the receiver system. Significant amounts of forward error correction (FEC) coding or RF signal power may be necessary to ensure that the probability of error for bits with a high bit-weight contribution to the PCM words is vanishingly small since errors in these bits may cause significant audio distortion in the reconstructed signal in the receiver system. However, a large amount of FEC coding may increase transmitter and receiver system complexity and increase power consumption. Furthermore, FEC codes which may be best suited for PCM words with high bit-weighting are not necessarily codes that achieve the best overall bit error performance for wireless communication systems, especially in challenging RF propagation environments.

Accordingly, it is a primary object of the present invention to overcome the above-mentioned difficulties by providing a high-fidelity wireless digital audio signal transmission system. Another object of the invention is to the enable the use of small, low-power wireless microphones or other transducers in interference-prone and noisy RF signal environments. Yet another object of the present invention is to generate a digital audio signal representation with low susceptibility to distortion due to possible errors in data recovery.

### OBJECTS AND SUMMARY OF THE INVENTION

Accordingly, it is a primary object of the present invention to overcome the above mentioned difficulties by providing an audio signal transmission system and method for robust, noise resistant transmission of audio signals.

Another object of the present invention is to enable placement of small, inexpensive wireless microphones or other transducers in noisy RF environments.

Yet another object of the present invention is efficiently synthesizing and transmitting a digital audio signal having a noise resistant signal structure.

The aforesaid objects are achieved individually and in combination, and it is not intended that the present invention be construed as requiring two or more of the objects to be combined unless expressly required by the claims attached hereto.

This invention fulfills the above-described needs in the art by providing a system for the transmission and reception of an audio signal using an oversampled and low bit-weight digital word representation. According to the invention, an analog audio electrical signal as detected by an acoustic transducer or microphone is digitized using a high precision oversampled delta-sigma modulator without corresponding digital decimation filter in the transmitter system. The delta-sigma modulator generates a sequence of words at a sampling frequency that substantially exceeds the critical (Nyquist) sampling frequency for the band-limited analog audio signal. Thus, the system is oversampled. The number of bits in each word generated by the delta-sigma modulator is small, less than about 5, so that the words have low bit weighting. In a preferred embodiment, each of the words generated by the delta-sigma modulator corresponds to a single bit, and each word is thus unweighted. According to the invention, the transmission of the oversampled and low bit-weight digital word representation of the audio signal instead of the conventional high bit-weight PCM word representation accomplishes multiple benefits. The system of the invention eliminates the need for the decimating lowpass filter, which is used in conventional sigma-delta ADC integrated circuits, in the transmitter system. The omission of the decimating lowpass filter significantly reduces the amount of power required for analog-to-digital conversion in the transmitter system since the decimating filter typically consumes the majority of the power in a delta-sigma ADC integrated circuit. According to the invention, the signal-processing burden for reconstruction of the audio signal by decimation and lowpass filtering is shifted to the receiver system, which in wireless microphone applications typically does not have the power restrictions associated with mobile or portable transmitter use. According to the invention, it is also surprising found that the transmission of an oversampled and low bit-weight word sequence reduces the deleterious effects caused by errors in the received bit sequence due to noise, interference, and multipath effects, thus improving receiver system performance.

The relatively uniform weight or equal importance of one bit compared to another in the low bit-weight word sequence system of the invention, in comparison and contrast to the conventional high bit-weight PCM word representation, permits the use of forward error correcting codes, such as convolutional codes, which do not distinguish among bit importance. Convolutional codes are known to provide good system robustness when implemented in wireless communication systems. Encoders for convolutional codes for use in the transmitter system are straightforward to implement, have low system latency, and require very low power, which are further advantages for battery-operated transmitter systems for delay-sensitive applications such as wireless microphones. Decoders in the receiver system for convolutional codes are more complex to implement than the transmitter system encoders, but increased complexity and power consumption in the receiver system is less important in many wireless microphone applications.

In certain embodiments of the invention, the oversampled and low bit-weight word sequence is encoded with a low-rate convolutional code, interleaved or shuffled to mitigate potential error bursts, and transmitted on a RF carrier signal using digital modulation methods to provide robust receiver system performance. According to the invention, multiple transmitters and receivers may operate in close physical proximity by using methods of frequency-division multiplexing, time-division multiplexing, or code-division multiplexing.

In a preferred embodiment of the system, the RF signal is generated to occupy spectrum in one of the unlicensed bands of operation as determined by the FCC in the United States or equivalent frequency spectrum authority elsewhere. For example, the FCC permits unlicensed operation of RF devices in the 900 MHz, 2400 MHz and the 5800 MHz band of frequencies. In certain embodiments of the invention, the digital method of modulation is differential quadrature phase-shift keying (DQPSK) of a RF carrier signal. In other embodiments, direct sequence spread spectrum (DSSS) or orthogonal frequency division multiplexing (OFDM) may be implemented in the transmitter and receiver systems, for example, those modulation methods implemented for wireless local area networks (WLANs) as defined by the Institute of Electrical and Electronics Engineers (IEEE) standards IEEE 802.11 parts a, b, g and its variations (commonly known as WiFi), especially when inexpensive and low-power integrated circuits are commercially available for modulation and demodulation.

In certain embodiments, a return-channel from the receiver system to each of the transmitter systems is provided to permit adaptive power control of the transmitter systems by the receiver system in order to minimize transmitter power consumption and inter-transmitter interference. The return-channel is preferably implemented with wireless RF or wireless infrared modulation methods. According to certain embodiments of the invention, when the transmitter system does not include a delta-sigma modulator in the transmitter analog-to-digital conversion, or when only a sequence of high bit-weight PCM words is available, the high bit-weight words are delta-sigma modulated in the digital domain or mapped using a residue number system (RNS) representation to generate a low bit-weight word sequence for transmission.

In certain embodiments of the invention, the oversampled and low bit-weight word representation (with delta-sigma modulator analog-to-digital conversion in the transmitter system and corresponding lowpass filtering for reconstruction in the receiver system, when necessary) is implemented in systems with a wired connection, for example, twisted pair cable, between the transmitter and receiver systems. In these embodiments, orthogonal frequency division multiplexing (OFDM) combined with adaptive transmitter modulation and high-order quadrature amplitude modulation (QAM) are implemented for the data encoding and digital modulation in the transmitter system and corresponding data decoding and demodulation methods in the receiver system.

The digital representation of the analog audio signal facilitates other optional enhancements of the system, including encryption of the transmitted signal to combat eavesdropping and unauthorized recording and the incorporation of sophisticated digital audio processing techniques, for example, psychoacoustic noise shaping, to enhance audio quality.

The above and still further objects, features and advantages of the present invention will become apparent upon consideration of the following detailed description of a specific embodiment thereof, particularly when taken in conjunction with the accompanying drawings, wherein like reference numerals in the various figures are utilized to designate like components.

### BRIEF DESCRIPTION OF THE DRAWINGS

FIG. 1 is a block diagram of a prior art wireless microphone transmitter system using analog frequency modulation (FM) for radio-frequency (RF) transmission.

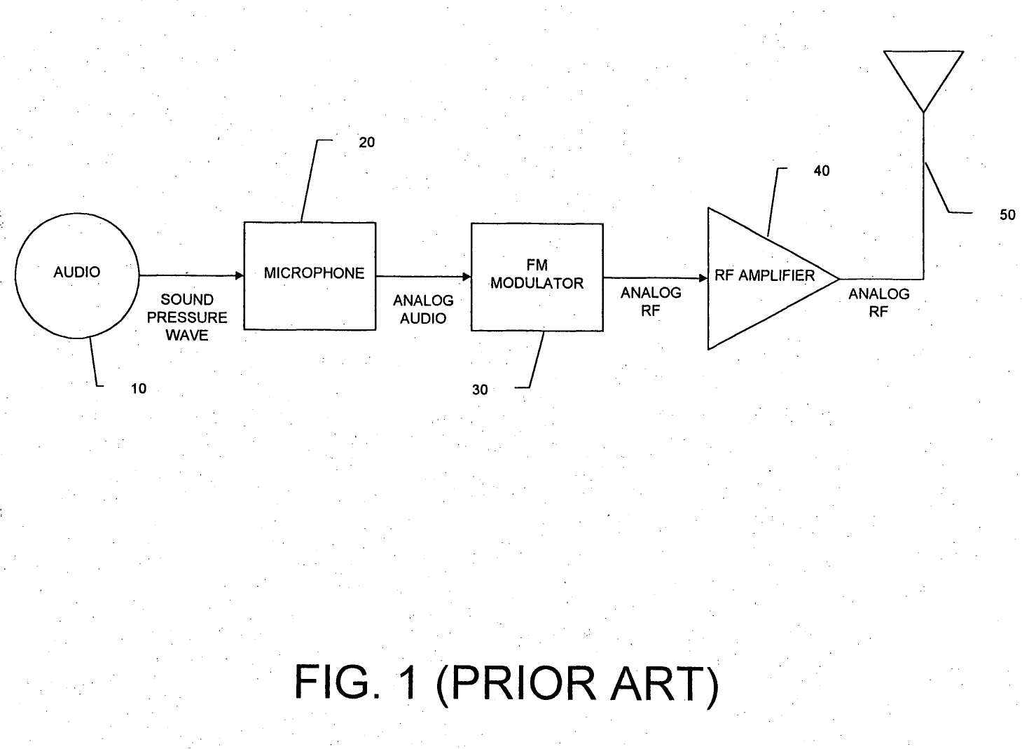

FIG. 2 is a block diagram of a prior art FM RF wireless microphone receiver system corresponding to the transmitter system of FIG. 1.

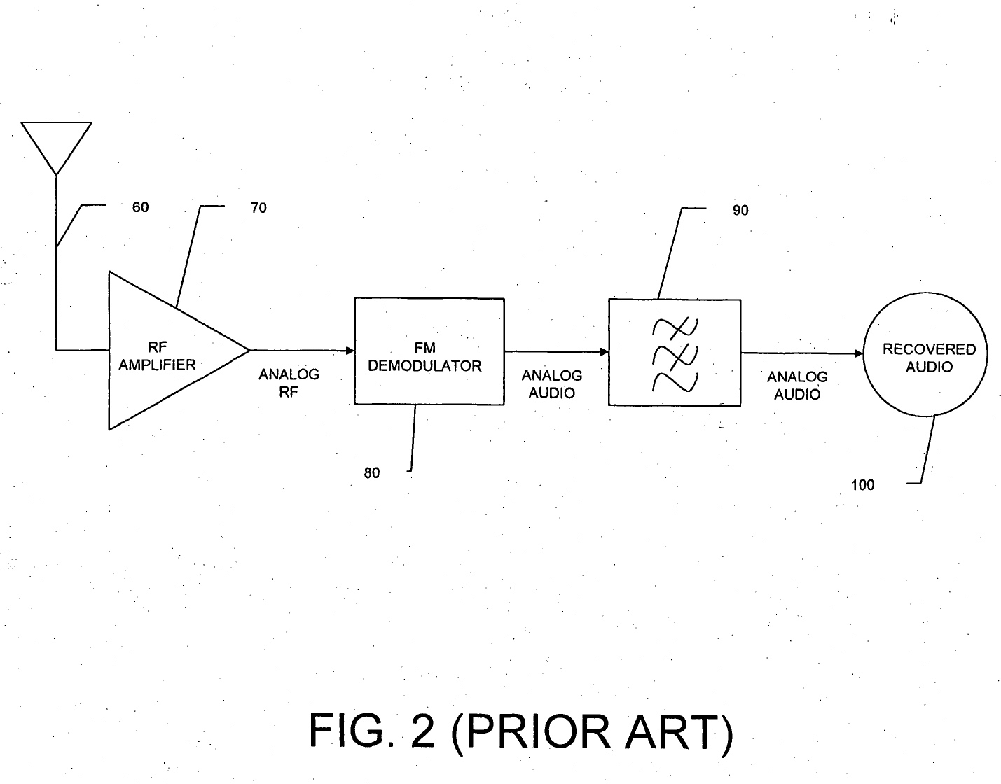

FIG. 3 is a block diagram of an embodiment of the transmitter system, in accordance with the present invention.

FIG. 4 is a block diagram of an exemplary embodiment of the data encoder in the transmitter system of FIG. 3, in accordance with the present invention.

FIG. 5 is a block diagram of an exemplary embodiment of the digital modulator in the transmitter system of FIG. 3, in accordance with the present invention.

FIG. 6 is a block diagram of an embodiment of a receiver system according to the invention that corresponds to the transmitter system of FIGS. 3-5, in accordance with the present invention.

FIG. 7 is a block diagram of an exemplary embodiment of a data decoder for use in the receiver system of FIG. 6 that corresponds to the transmitter system data encoder of FIG. 4, in accordance with the present invention.

### DESCRIPTION OF THE PREFERRED EMBODIMENTS

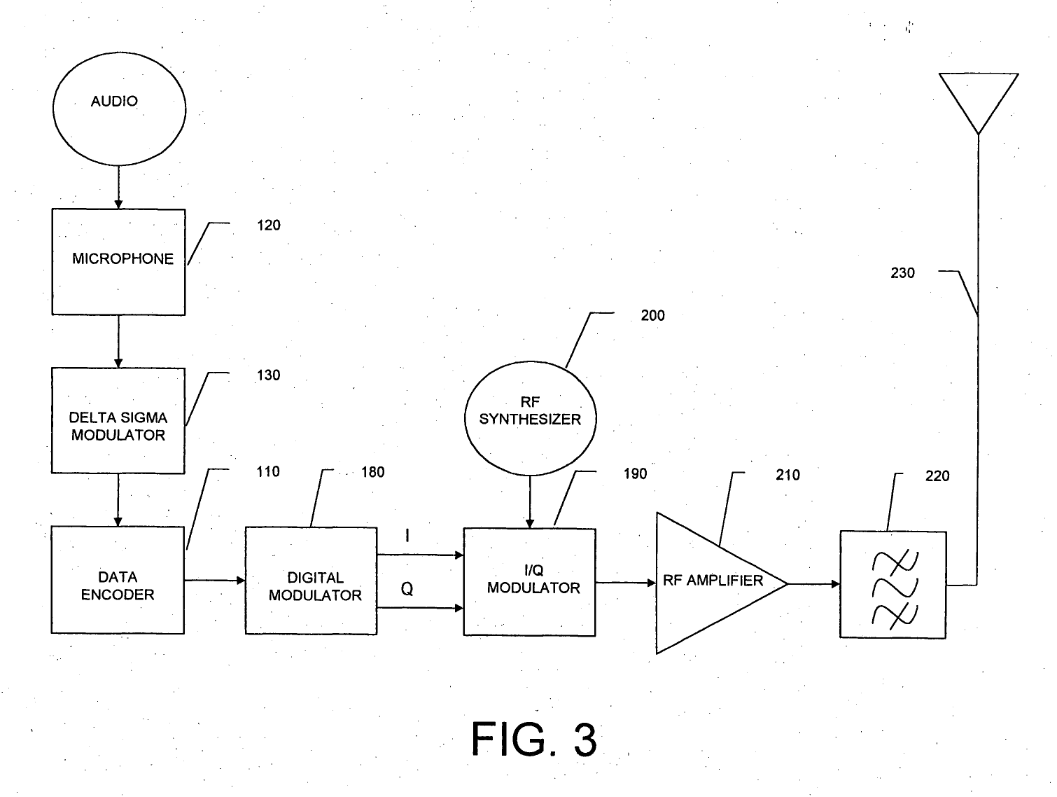

Referring now more particularly to FIGS. 3-7, FIG. 3 is a block diagram of the transmitter system according certain embodiments of the invention. An audio sound pressure wave is detected by a microphone 120 or equivalent acoustic transducer and converted to an analog (electrical) signal. In the preferred embodiment, the analog audio signal generated by the microphone is propagated to audio delta-sigma modulator 130. The implementation of delta-sigma modulator 130 for analog audio signals is conventional and is known in the art [see also: John Watkinson. The Art of Digital Audio. 2nd edition. Oxford: Focal Press, 1994, pp. 142-172 and U.S. Pat. No. 6,326,912 to Fujimori, issued Dec. 4, 2001.] However, most commercially available ADC integrated circuits for audio applications that incorporate a delta-sigma modulator also incorporate the corresponding decimation lowpass filter, which is used to convert the output signal from delta-sigma modulator 130 to a conventional high bit-weight PCM word representation. According to the invention, the high bit-weight PCM word representation is not required and is not preferable for transmission by the transmitter system. Delta-sigma modulator 130 generates a digital signal that is a sequence of words representing the analog audio signal. The digital signal word frequency is substantially larger than the Nyquist (critical) sampling frequency for the audio signal information. For human hearing, the critical sampling frequency is about 40 kHz. The delta-sigma modulator sampling frequency is substantially oversampled when compared to the conventional pulse code modulation sampling frequency (e.g. 44.1 kHz), typically at least eight (8) times the conventional pulse code modulation sampling rate, and preferably a factor of sixty four (64) in certain embodiments. Each word in the sequence that forms the digital signal consists of m bits, where m is a small integer between one (1) and four (4) and is preferably one (1). According to the invention, it is this digital signal or sequence with low bit-weight words that is used as the source bit information for wireless transmission using a digitally modulated RF signal and not the conventional high bit-weight PCM word sequence. In certain embodiments of the invention, m=1, and the one-bit delta-sigma modulator word (sampling) frequency is 2.8224 MHz (i.e. 64 times oversampled with respect to a 44.1 kHz sample frequency). The remaining processes shown in the FIG. 3 transmitter system block diagram are an exemplary embodiment of how the oversampled and low bit-weight word sequence is encoded and modulated onto a RF carrier signal for free space propagation using digital modulation methods.

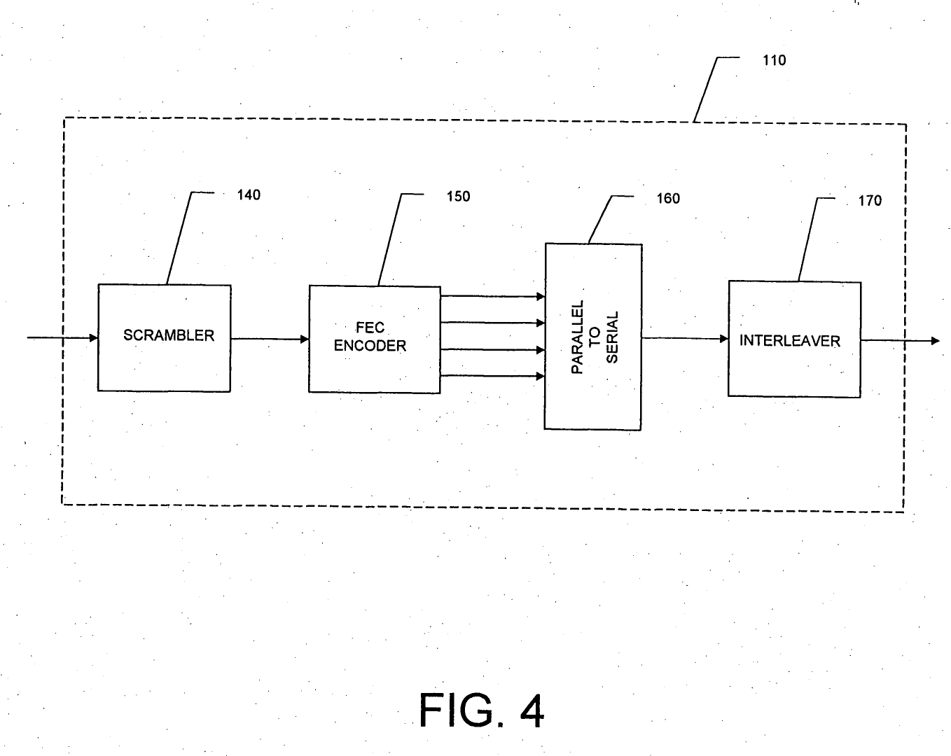

After delta-sigma modulation 130, the oversampled and low bit-weight word sequence (digital signal) is propagated to data encoder 110. Data encoder 110 scrambles the digital signal in a deterministic manner and encodes the signal with a forward error correcting (FEC) code to improve receiver system robustness, generating a digital signal suitable for use in digital modulator 180. FIG. 4 shows an exemplary embodiment of data encoder 110 in the FIG. 3 transmitter system. In a preferred embodiment, the word sequence from delta-sigma modulator 130 is propagated to bit scrambler 140. As delta-sigma modulator 130 generates each bit (when m=1), it is summed using binary arithmetic (i.e. modulo-2) with a bit determined in scrambler 140. The function of scrambler 140 is to randomize the sequence generated by delta-sigma modulator 130 through binary addition with a varying (but deterministic) sequence, so that the probability of long sequences of consecutive ones or zeroes is small. Thus scrambler 130 accomplishes energy dispersal of the delta-sigma modulator output sequence. The randomizing sequence is known as a pseudonoise (PN) sequence and may be implemented as a shift register with feedback, for example, using the polynomial x⁹+x⁵+1. After scrambling 140, the digital signal is propagated to forward error correction (FEC) encoder 150 that implements a low rate convolutional code encoder in a preferred embodiment. FEC encoder 150 is a finite state machine (FSM) and is implemented as a shift register with feedback. In certain embodiments, the convolutional code is nonsystematic and has rate one-half (½) or one-fourth (¼), a constraint length of 7, and generating polynomials given by 133, 171, 145, and 133 in octal representation. Methods for implementing convolutional code encoder with shift registers are known [see also: Clark and Cain. Error-Correction Coding for Digital Communications. New York: Plenum Press, 1981, pp. 227-242, and 399-407]. For the rate one-half (½) implementation only the 133 and 171 generating polynomials are used. For the rate one-fourth convolutional encoder implementation, encoder 150 generates four output bits for each input bit. The effective data rate for the embodiment of the invention where delta-sigma modulator 130 operates at a 2.8224 MHz sampling frequency is 11.2896 megabits per second after FEC encoding. The four output bit sequences from convolutional encoder 150 are multiplexed into a single bit sequence by parallel-to-serial converter 160, also known as a demultiplexor (DEMUX). For the rate one-half convolutional encoder implementation, encoder 150 generates two output bits for each input bit. The effective data rate for the embodiment of the invention where delta-sigma modulator 130 operates at a 2.8224 MHz sampling frequency is then 5.6448 megabits per second after FEC encoding. Since the rate one-half and rate one-fourth convolutional codes share the same generating polynomials, the transmitter system is preferably implemented so that the transmitter user may select either configuration. In the preferred environment, interleaver 170 preferably shuffles the bit sequence after FEC encoding and parallel-to-serial conversion according to a predetermined pattern, so that consecutive bits before interleaving are substantially separated after interleaving 170. The interleaving operation is deterministic and forms a one-to-one correspondence so that effects of the interleaving may be reversed in the receiver system. Methods for interleaving for bit sequences are known [see also: John Watkinson. The Art of Digital Audio. 2nd edition. Oxford: Focal Press, 1994, pp. 142-172, pp. 334-337].

Bit interleaving in the transmitter system with corresponding bit deinterleaving in the receiver system helps to minimize the effect of error bursts due to short intervals of interference and noise. Interleaving is important when the system of the invention is implemented for emission of RF signals in the unlicensed RF bands of operation, where other unrelated devices may generate RF signals whose spectrum overlaps the spectrum of the desired signal. In wireless microphone systems, overall system latency is an important consideration. It has been found that temporal resolution of human auditory perception is about two (2) milliseconds, so that the length of the interleaver should be less than about one (1) millisecond, which corresponds to several thousand bits at megabit per second data rates. In applications where latency is less important, the interleaver length may be increased. In applications where latency is critically important, the interleaver length may be decreased. However, in most implementations, the interleaver length should correspond to at least several hundred bits so that a bit length greater than the effective memory of the convolutional code separates consecutive bit errors as detected in the receiver system prior to deinterleaving.

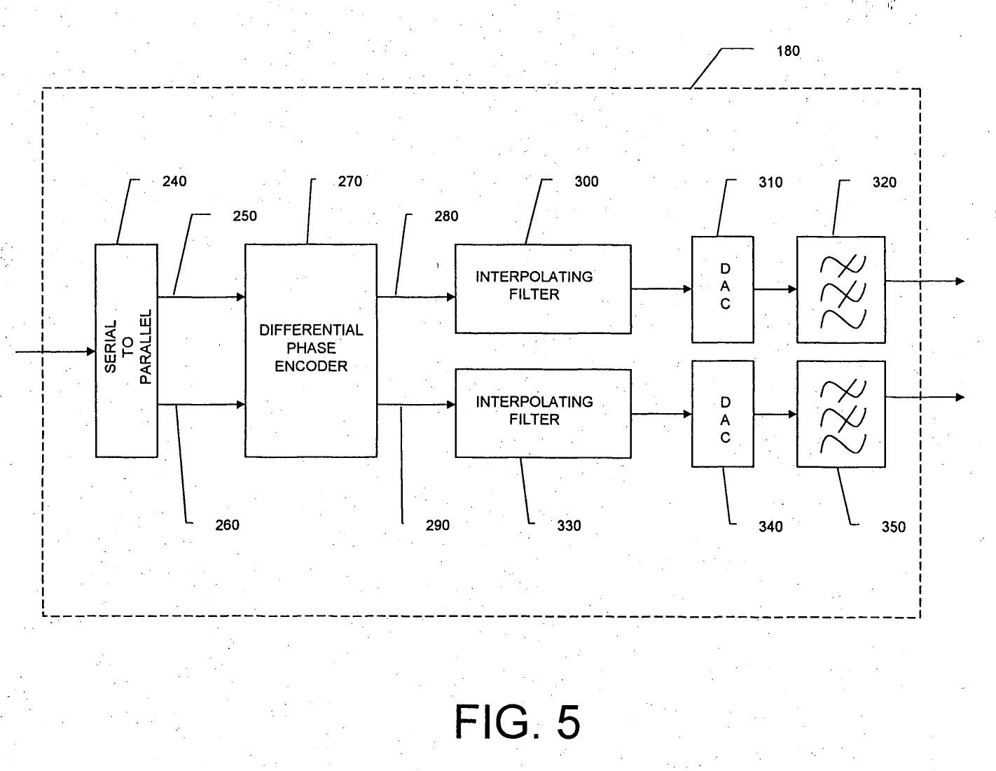

With reference to FIG. 3, the convolutional encoded and interleaved bit sequence from data encoder 110 is propagated to digital modulator 180. The specific implementation of digital modulator 180 varies according to the characteristics of the desired RF band of operation of the system. An exemplary embodiment of digital modulator 180 is shown in FIG. 5 and is described subsequently. In certain embodiments of the invention, it is preferable that the transmitter system be implemented so that the RF signal is generated in one of the unlicensed bands of operation as provided by the FCC in the United States or equivalent frequency spectrum authority elsewhere. In the United States, FCC Part 15 Rules and Regulations, specifically section 15.247, provides the relevant restrictions. At the time of this writing, unlicensed operation of RF devices subject to maximum power, maximum spectrum occupancy, spectral purity and minimum bandwidth restrictions are permitted in the United States in the 900 MHz, 2400 MHz and 5800 MHz RF bands. More specifically, the unlicensed bands are i) 902 MHz through 928 MHz, ii) 2400 MHz through 2483.5 MHz, and iii) 5725 MHz though 5850 MHz. The FCC may determine other frequency bands for unlicensed use in the future and the system of the invention is applicable to these bands. The system of the invention may also be used in corresponding unlicensed bands in areas outside of the United States.

The output signal from digital modulator 180 is either the RF signal at an intermediate frequency (IF), the RF signal at the desired emission frequency, or a baseband representation of the desired RF signal, depending upon the implementation. In the embodiment of the invention shown in FIG. 3, digital modulator 180 generates two analog signals, the in-phase (I) analog signal and the quadrature (Q) analog signal. The in-phase and quadrature (I and Q) analog signals are propagated to I/Q modulator 190 to generate the desired RF signal. For example, the RF2948B integrated circuit from RF Micro Devices accepts analog I and Q signals and an analog RF carrier (i.e. unmodulated) signal and generates a modulated RF signal for operation in the unlicensed 2400 MHz band described previously. An unmodulated RF carrier signal suitable for use with the RF2948B may be generated by conventional RF synthesizer 200, for example, the Silicon Laboratories 4136 RF synthesizer for operation in the 2400 MHz unlicensed band. After I/Q modulator 190, the analog RF signal is propagated to RF power amplifier 210, which may be a RF Micro Devices RF5117 integrated circuit RF amplifier for the 2400 MHz unlicensed band. The amplified RF signal is bandpass filtered 220 to substantially confine spectral emissions to the desired RF band of operation and is coupled to transmitting antenna 230 for free space propagation.

FIG. 5 is a block diagram of digital modulator 180 in FIG. 3 according to an embodiment of the invention. After encoding in data encoder 110, the digital signal is propagated to serial-to-parallel converter 240, also known as a multiplexor (MUX), which separates consecutive bits in the bit sequence to generate two bit sequences. The bit rate of each of the resulting sequences 250 and 260 is one-half (½) of the bit rate after interleaving 170 and before serial-to-parallel converter 240. For example, in a preferred embodiment where one-bit delta-sigma modulator 130 sampling frequency is 2.8224 MHz and a rate one-fourth convolutional FEC code is implemented, the bit rate after serial-to-parallel converter 240 is 5.6448 megabits per second. Correspondingly, the bit rate after serial-to-parallel converter 240 for the rate one-half 2.8224 MHz implementation is 2.8224 MHz. After serial-to-parallel conversion 240, the pairs of bits are differentially phase-encoded in differential phase encoder 270. Differential phase encoder 270 implements a bit pair mapping equivalent to differential quadrature phase shift keying (DQPSK) modulation. In DQPSK encoder 270, each input bit pair b₁ b₀, where b₁ and b₀ are binary digits, corresponds to an absolute phase of 0[0 0], π/2[0 1], π [1 1], or 3π/4[1 0] radians, in other words, using Gray coding. In DQPSK modulation, instead of transmitting the absolute phase value, the difference between the current phase and the previous phase is determined, and a bit pair corresponding to the phase difference is encoded. For example, a phase difference of 0 radians corresponds to an encoded bit pair [0 0], a phase difference of π/2 radians corresponds to an encoded bit pair [0 1], a phase of difference of π radians corresponds to an encoded bit pair [1 0], and a phase difference of 3π/4 radians corresponds to an encoded bit pair [1 1]. Differential encoding in the transmitter system simplifies receiver system phase tracking and makes the receiver system less sensitive to carrier frequency stability at high frequencies, which an important concern when the RF signal is operated in the high-frequency unlicensed bands. The remaining processing for each of output signals 280 and 290 from differential encoder 270 are symmetric. Output digital signal 280 is propagated to interpolating lowpass filter 300. After lowpass filtering 300, the digital signal is converted to an analog (electrical) signal in digital-to-analog converter (DAC) 310. After DAC conversion 310, the analog signal is lowpass filtered 320 and propagated to FIG. 3I/Q modulator 190 as the I signal. Correspondingly, output digital signal 290 is propagated to interpolating lowpass filter 330. After filtering 330, the signal is propagated to digital-to-analog converter (DAC) 340 for analog conversion and then to analog lowpass filter 350. After lowpass filtering 350, the resulting signal is propagated to I/Q modulator 190 as the Q signal input shown in FIG. 3. Each of interpolating lowpass filters 300 and 330 is an up-sampling rate converter, also known as a zero-stuffing interpolator, followed by a short finite impulse response (FIR) digital filter. For example, interpolating lowpass filters 300 and 330 may be implemented with 1:8 factor interpolation (in other words, 7 zeroes of bit stuffing for each bit), following by a root raised-cosine (RRC) FIR filter with a shape factor equal to 0.5. The design of interpolating filters 300 and 330 is known in the art, for example, as implemented in the Intersil HSP50415 wideband programmable modulator integrated circuit device. The function of digital filters 300 and 330 is to perform limited-complexity interpolation and subsequent lowpass filtering in the digital domain in order to simplify the required analog lowpass filtering after digital-to-analog conversion by DACs 310 and 340. Analog lowpass filters 320 and 350 are implemented as 2nd order lowpass filters in certain embodiments.

According to certain embodiments of the transmitter system shown in FIGS. 3-5, the emitted RF signal has a first null-to-null bandwidth of 2.8224 MHz for the rate one-half encoded system sampled at 2.8224 MHz, or a null-to-null bandwidth of 5.6448 MHz for the rate one-fourth encoded system, also sampled at 2.8224 MHz. In either implementation, the overall system exhibits processing gain of at least about 10 dB. This is a requirement for operation in certain of the unlicensed RF bands. The processing gain is achieved by the use of a relatively low-rate (rate less than or equal to one-half) convolutional codes and the oversampled representation, which together accomplish spreading of the audio information more efficiently than if conventional direct-sequence codes are used for spreading high bit-weight PCM words. The use of the rate one-half code is advantageous if i) the RF band is relatively free of interference, or ii) a large number of transmitter systems are to be used simultaneously. In system embodiments with multiple operating transmitters, each transmitter system is assigned a fraction of the available bandwidth, so that the RF signals emitted by the transmitter systems are substantially frequency-orthogonal to one another. For example, in the 900 MHz unlicensed RF band, up to 9 transmitter systems according to the invention could be operated in close physical proximity within the available bandwidth using the rate one-half FEC code implementation versus only 4 simultaneous co-located transmitters for the rate one-fourth FEC code implementation. Configuring a transmitter system to operate at a different carrier frequency within a reasonable range of frequencies requires changing the desired frequency of the RF carrier signal generated by RF synthesizer 200.

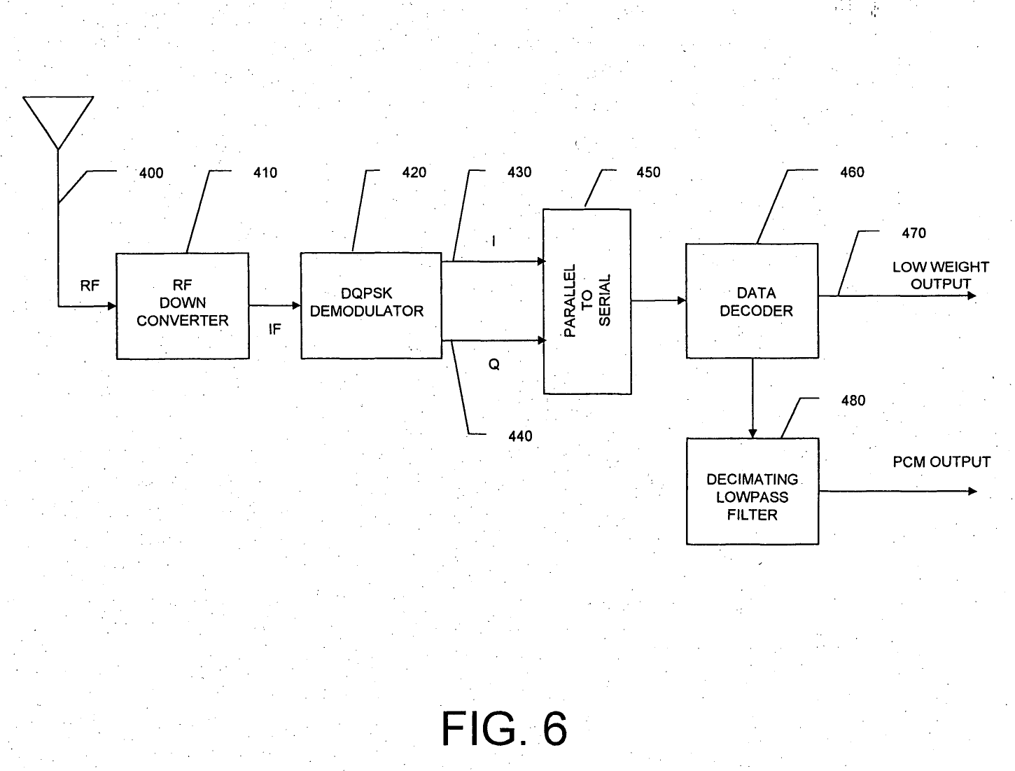

FIG. 6 is a block diagram of a receiver system of the invention corresponding to the FIG. 3 transmitter system. The free space propagating RF signal is received by receiving antenna 400. The received analog (electrical) RF signal is frequency-translated by RF down-converter 410 to an intermediate frequency (IF) representation. RF down-conversion 410 to an IF representation simplifies the implementation of the subsequent signal processing and permits receiver operation for RF signals with different frequencies by adjustment of only RF down-converter 410. In many embodiments, RF down-converter 410 includes a bandpass filter and low-noise amplifier, mixer and RF synthesizer, for example, the RF2948B integrated circuit from RF Micro Devices, described previously. In certain embodiments, RF down-conversion is not necessary, for example, in so-called zero-IF or direct conversion receiver systems. After down-conversion 410, the RF signal is propagated to DQPSK demodulator 420. DQPSK demodulator 420 demodulates the RF signal at the IF representation or zero-IF representation according to known methods of demodulation for differential quadrature phase-shift keying (DQPSK) signals. Typically, these processes are (not shown) I/Q demodulation and separation, carrier frequency and phase tracking using a Costas loop, and differential decoding [see also: U.S. Pat. No. 5,379,323 to Nakaya, issued Jan. 3, 1995]. DQPSK demodulator 420 generates inphase (I) and quadrature (Q) digital signal estimates 430 and 440, respectively. These are the received estimates of the transmitted I and Q digital signals 250 and 260, respectively, prior to differential encoding as bit pairs in the FIG. 5 transmitter system. The received I and Q signal estimates are propagated to parallel-to-serial converter (DEMUX) 450 to generate a bit sequence. The resulting bit sequence is propagated to data decoder 460. Data decoder 460 implements deinterleaving, FEC decoding and descrambling for the corresponding interleaving, FEC encoding and scrambling in data encoder 110 in the transmitter system. After data decoding 460, the resulting bit sequence substantially approximates, except for the occurrence of bit errors, the transmitted oversampled and low bit-weight word sequence from delta-sigma modulator 130 in the FIG. 3 transmitter system. In certain embodiments of the receiver system, it is desirable to maintain the oversampled and low bit-weight word representation as the final digital signal representation, which is propagated beyond the receiver system as serial digital audio signal 470. An advantage of this embodiment is that the transmitter and receiver system of the invention introduce no distortion or other digital artifacts after initial delta-sigma modulation, other than bit errors, which may occur in the receiver. It is known that delta-sigma ADC integrated circuit performance is sensitive to the implementation of the decimating lowpass filter used in the converter to generate the conventional high bit-weight word representation. According to the invention, the use of the delta-sigma modulator signal output without the corresponding decimation filter in the transmitter system eliminates the potential for digital distortion introduced by the decimating filter. Thus, a single digital decimating filter may be implemented outside of the transmitter and receiver system of the invention, for example, at the end-use of the serial digital audio signal for PCM word reconstruction or digital-to-analog conversion.

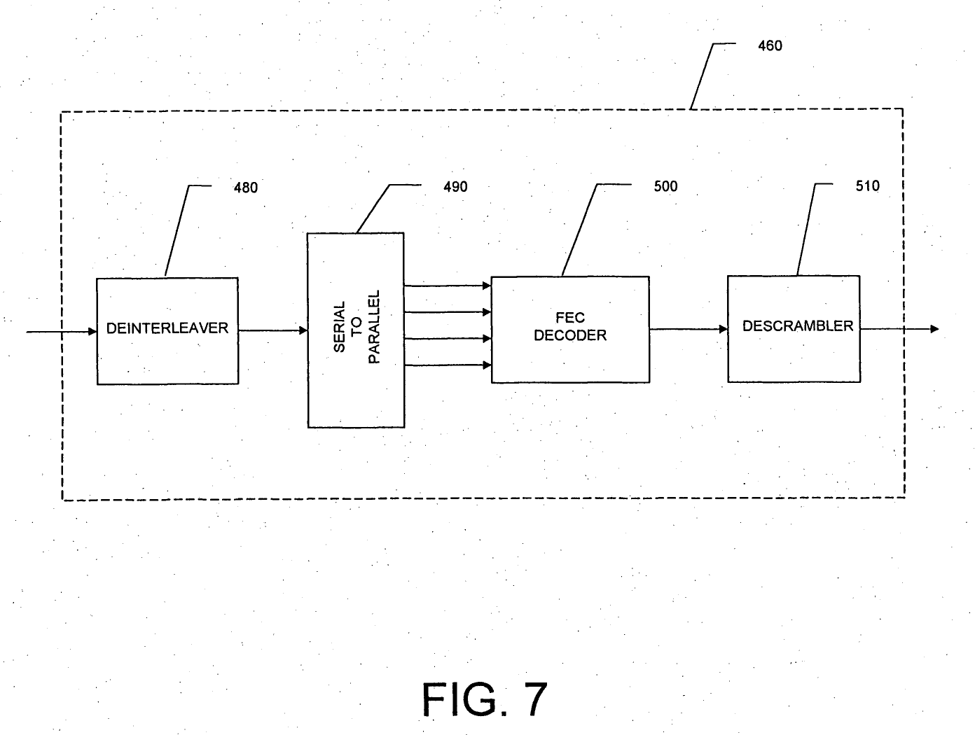

FIG. 7 is a block diagram of data decoder 460. The received estimated digital signal is deinterleaved 480, reversing the effect of transmitter system interleaver 170. Deinterleaving breaks up potential error bursts in the received data signal estimate. The deinterleaved signal estimates are converted from a serial-to-parallel representation in converter 490 (MUX) and propagated to FEC decoder 500. In a preferred embodiment, FEC decoder 500 implements soft-decision Viterbi decoding algorithm for the corresponding convolutional code used in the transmitter system. For the one-half code rate implementation, serial-to-parallel converter 490 has two (2) digital signal branches, and for the one-fourth code rate implementation, converter 490 has four (4) output signal branches. Methods for implementing Viterbi decoding are known in the art [see also: Clark and Cain. Error-Correction Coding for Digital Communications. New York: Plenum Press, 1981, pp. 227-265]. After Viterbi decoding 500, the resulting digital sequence is descrambled 510. Descrambler 510 reverses the effect of scrambler 140 in the transmitter system. The descrambled output sequence is, in the absence of errors, substantially the same as the transmitted delta-sigma modulator output signal.

In certain embodiments of the receiver system, it may be desirable to generate high bit-weight PCM words from the received low bit-weight word sequences, for example, if the audio signal from the receiver system is propagated to subsequent systems that expect a conventional high-bit weight PCM format such as that used in the compact-disc (CD). This is accomplished in the receiver system by implementing digital decimating lowpass filter 480 in the FIG. 6 receiver system. Lowpass filter 480 implements a high-order finite impulse response (FIR) digital filter and digital decimator to reduce the sampling frequency to the desired output word sampling frequency, for example, 44.1 kHz for the CD format. Lowpass filtering is also necessary when the desired output signal from the receiver system is an analog audio signal, for example, to be used with a conventional audio amplifier and speakers or headphones. The design of the lowpass filter characteristic typically includes compensations for known effects of the delta-sigma modulation.

The preferred embodiment of the invention is for operation of the transmitter and receiver system with an RF signal generated in an unlicensed RF band. However, in certain embodiments of the invention, the transmitter and receiver system may be implemented in licensed RF bands, for example in unoccupied frequency spectrum in the UHF and VHF bands. Some prior art analog FM wireless microphone systems operate in the UHF or VHF bands, using relatively small amounts of spectrum (less than 200 kHz) and small amounts of power (less than about 50 milliwatts). The FCC permits operation in these licensed frequency bands on a secondary use basis only. In these embodiments, there is typically insufficient spectrum to permit wideband digital modulation methods described previously. Implementation of the system of the invention for operation in such RF bands may require that digital modulator 170 be implemented using known methods of multicarrier modulation (MCM) and high-order quadrature amplitude modulation (QAM) (not shown). For example, 32-state, 64-state, or 256-state QAM and orthogonal frequency division multiplexing (OFDM), which is a type of MCM, may be used to transmit the required data rate in a relatively small amount of available frequency spectrum. However, high-order QAM combined with OFDM modulation is typically more expensive to implement than the FIG. 4 digital modulator and typically requires more power to achieve the same level of robustness when compared to wideband systems. In certain embodiments, operation in licensed frequencies may be preferable when there is severe spectrum congestion in the unlicensed RF bands due to other operating RF devices in close physical proximity. In certain high-order QAM demodulation methods, the error rates for the received bits are not approximately equal. For example, there may be two classes of bits, class I and class II. Class I bits may, in general, have a lower received error rate than class II bits because of greater effective interbit distance for those bit positions in the transmitted signal constellation. According to the invention, in these embodiments, when delta-sigma modulator 130 generates a sequence with word widths greater than one (1) bit, the more significant bits from delta-sigma modulator 130 are mapped to those QAM modulation bits that are less likely to be in error. For example, when the output word width is two (2) bits, and the QAM system has two error classes, as described previously, the more significant bit in each word is mapped to a class I modulation bit, and the least significant bit in each word is mapped to a class II bit. In such implementations, each class of bits must be separately interleaved in the transmitter system and separately deinterleaved in the receiver system, or the bits in each word must be grouped together as a symbol (i.e. word) and interleaved together using a symbol interleaver and symbol deinterleaver instead of a bit interleaver and bit deinterleaver in order to prevent bit classes from being intermingled.

In certain embodiments of the invention (not shown), it is desirable that there be communication from the wireless microphone receiver system to the one or plurality of transmitter systems. This back channel or return-channel is used to convey small amounts of digital information to modify performance characteristics of the transmitter systems automatically and without transmitter user intervention. The required data throughput of the return-channel is small (much less than one kilobit per second) compared to the relatively high data throughput required to convey the digital audio signal representation from one or more transmitters to the receiver. In these embodiments, substantially continuous operation of the return-channel operation is not required. Because of the relatively low data throughout and only occasional need for return channel communication, the return channel may be implemented with known inexpensive wireless infrared, or preferably, RF wireless technology. For example, the Infrared Data Association (irDA) defines infrared wireless communication standards, and low-cost integrated circuits for infrared communication are available. Inexpensive and low-power integrated circuits for RF wireless standards are also available, for example, devices using the BlueTooth™ Human Interface Device (HID) specification as defined by the IEEE 802.15.1 standard. According to the invention, the return-channel is used in certain embodiments to signal each of the transmitter systems for a corresponding receiver system to increase or decrease the transmitter system power in order to improve receiver system performance or to increase transmitter battery life, respectively. In certain embodiments of the invention, the receiver system determines the approximate signal-to-noise ratio (SNR) according to each of the received transmitter signals and communicates to each of the transmitter systems a message or command via the return-channel to increase or decrease its power in order to maintain an approximately equal SNR ratio as detected by the receiver system among all operating transmitters sufficient for reliable error-free operation. In certain embodiments, this corresponds to a received SNR of at least about 10 dB to 20 dB (bit energy to noise energy decibel ratio). Adaptive power management of the transmitter systems by the receiver system also helps to reduce interference caused by the transmitter systems to other devices operating in the same RF band of frequencies and reduces the potential for interference between transmitter systems. In certain embodiments of the invention, the return channel may be used to convey from the receiver to transmitters a change in the operating frequency of the transmitters in the event of severe spectrum congestion.

In certain embodiments of the invention (not shown), the oversampled and low bit-weight word representation of the audio signal may be communicated using a transmitter and receiver system implemented using third generation (3G) cellular telephone link technology, which supports a digital data interface. In this embodiment, the delta-sigma modulator output signal is coupled to the cellular digital interface instead of using the digital modulation methods shown in FIGS. 3-5. However, at the time of this writing, such devices are not available, and it is highly probable that they would be much more expensive to manufacture and operate than the system embodiment shown in FIGS. 3-5 and other described embodiments.

In certain embodiments of the invention (not shown), the data encoding and digital modulation methods for encoding the oversampled and low bit-weight word sequence from the delta-sigma modulator output may be implemented using a known standard for wireless local area networking (WLAN) instead of convolutional encoding, interleaving, and DQPSK modulation as described previously. For example, standards known as IEEE 802.11a, for operation in the 5400 MHz unlicensed RF band, and IEEE 802.11b or IEEE 802.11 g, for operation in the 2400 MHz unlicensed RF band, define transmitter and receiver systems for the wireless transmission and reception of general computer data. In these embodiments, the forward error correction (FEC), if present, and digital modulation are performed according to the respective physical interface layer (PHY) defined by the standard. For example, in the IEEE 802.11b standard, direct-sequence spread spectrum (DSSS) modulation combined with complementary code keying (CCK) is found to achieve bit rate throughputs of up to 11 megabits per second, with extensions to 22 megabits per second. This data rate is sufficient to support multiple operating transmitters using an oversampled low bit-weight word representation according to the invention. However, the original WLAN standards were not developed for applications that require low-latency and continuous operation at a low error rate. Instead, the WLAN standards use a packet-oriented protocol intended for computer operation, and the media access control (MAC) protocol layer assumes that packets of data occur in bursts and that a packet may be retransmitted from the transmitter to the receiver in the event of bit errors. This is not practical for a wireless microphone system where the bit sequence cannot in general be interrupted and retransmitted at irregular intervals. There has been recent interest by the standards groups in developing new protocols to address this deficiency so that the WLAN systems may be used for general-purpose multimedia applications. Some of these concerns are being addressed under the IEEE 802.11e draft proposal for quality-of-service (QoS). The objective of the new proposal is to provide guaranteed WLAN bandwidth with low latency and some amount of forward error correction to prevent the need for packet retransmission. In certain embodiments of the invention, when low cost integrated circuits implementing low-latency WLAN standards that address system QoS issues for continuous digital audio are available, then the oversampled and low bit-weight word representation of the audio signal according to the invention may be used with such systems. An advantage of using WLAN modulation methods is that a return channel is automatically provided since WLAN standards incorporate two-way communication, so that a separate return-channel using a different modulation method, for example, by Bluetooth™ HID or infrared, is unnecessary. According to certain embodiments of the invention, multiple transmitter operation with WLAN implementations is accomplished by time-division multiplexing (TDM) since the data rate capability of the WLAN physical layer exceeds the data rate requirement for each transmitter. Each transmitter system is allocated a specific interval of time in which to transmit a high data rate burst, and the receiver system receives burst signals from all operating transmitters in a round robin manner, maintaining isosynchronous data flow. Operation in this mode requires coordination by the receiver system, so that all operating transmitter systems receive a timing signal, transmitted by the receiver system.

According to certain embodiments of the invention (not shown), the oversampled and low bit-weight word representation with delta-sigma modulator analog-to-digital conversion in the transmitter system and corresponding lowpass filtering, when necessary, for audio signal reconstruction in the receiver system, may be implemented for wired systems, for example, when the transmitter and receiver systems are connected with twisted-pair wiring. These embodiments have certain advantages over the use of long runs (hundreds of feet) of conventional shielded microphone cable because of the robustness of the received digital signal, especially when appropriately modulated, against deleterious effects caused by the physical characteristics of the interconnecting cable (e.g., signal loss and dispersion) and when operating in environments with significant amounts of electrical noise. However, in these embodiments, the digital modulation and demodulation methods are typically different from the DQPSK system shown in FIGS. 3-7. For example, to achieve very high bit rates with twisted-pair wiring, the use of OFDM and high-order QAM, described previously for narrowband licensed RF band operation of the invention, together with adaptive transmitter modulation based on receiver feedback as used in digital subscriber loop (DSL) technology may be required. DSL systems over twisted-pair lines can achieve one-way data rates in excess of 3 megabits per second, which is sufficient for the oversampled low bit-weight word representation of the invention.

According to certain embodiments of the invention (not shown), the high bit-weight PCM words in a sequence from a conventional delta-sigma ADC with corresponding decimation filter may be converted to a sequence with low bit-weight words in the transmitter system through a delta-sigma operation implemented in the digital domain to generate the corresponding low bit-weight word sequence. However, in general, this is wasteful of circuit complexity and power and is not a preferable mode of operation since the desired low bit-weight word sequence may be directly available at the delta-sigma modulator output. In general, this embodiment of the invention should be considered only when the delta-sigma modulator output signal is not available, for example, when the audio samples have been previously encoded as PCM words with a large number of bits, or when the ADC is not implemented with delta-sigma modulation. According to the invention, another method of mapping a high bit-weight word sequence to a low bit-weight word sequence for transmission is to re-encode the high bit-weight samples using a residue number system (RNS) representation prior to transmission. However, this method also involves additional circuit complexity and is not the preferred implementation.

The described transmitter and receiver system of the invention may also be used in applications other than wireless microphone systems. Its use may be advantageous in many applications in which a bandwidth-limited analog signal may be represented by an oversampled and low bit-weight word sequence and where robust wireless transmission, high signal quality and fidelity, low latency and low transmitter power are important considerations.

It will be appreciated by those of skill in the art that the foregoing makes available a method and system for the wireless radio-frequency (RF) transmission and reception of an audio signal using a substantially oversampled and low bit-weight digital word representation. In the wireless microphone embodiment of the invention, an analog electrical signal, representing acoustic audio information, from a microphone or equivalent transducer is digitized in the transmitter system with a high-precision delta-sigma modulator without corresponding decimating lowpass filter. In the preferred embodiment, the delta-sigma modulator output is a sequence of single bit words. Each bit is thus considered unweighted or, equivalently, equally weighted. In other embodiments, the delta-sigma modulator output sequence is generated to have low bit-weight words. In order to preserve audio signal quality using unweighted or low bit-weight words, the words or samples are generated at a frequency that substantially exceeds the critical (Nyquist) sampling frequency for the band-limited audio signal, so that the signal is substantially oversampled. According to the invention, the oversampled and low bit-weight digital word representation minimizes the complexity and power consumption of analog-to-digital conversion in the transmitter system, which facilitates mobile or portable use with long battery life. The corresponding digital decimating lowpass filter is implemented in the receiver system, when necessary. In certain embodiments of the receiver system of the invention, the decimating filter is not required when it is desirable to maintain the oversampled and low bit-weight word representation, such as for subsequent transmission, or for storage and archiving without introducing digital filtering artifacts. It is surprisingly found that the oversampled and low bit-weight word representation also reduces the deleterious effects of bit errors in the receiver system, particularly for isolated single bit errors. In certain embodiments of the transmitter system, the oversampled low bit-weight word sequence is encoded with a low-rate convolutional code. The encoded sequence is then interleaved and modulated using digital modulation methods to provide a robust wireless audio communication system. The method and system may be extended to a plurality of operating transmitters and receivers by frequency division multiplexing, time-division multiplexing, or spread spectrum code multiplexing.

Broadly speaking, the invention comprises a signal processing method and system for wireless audio transmission using low bit-weight words (i.e., digital words having 4 or fewer bits, preferably single bit words). An audio signal provided by a microphone or the like is substantially over-sampled, preferably using a high-precision delta-sigma modulator without the conventionally attached decimating low pass filter. Preferably, the delta sigma modulator output is a sequence of single-bit words generated at a sampling rate that substantially exceeds the Nyquist sampling frequency. For conventional audio, the Nyquist sampling frequency is on the order of 40 Kilohertz (KHz) and, in the method of the present invention, a sampling frequency substantially higher than 40 KHz is employed. A receiver adapted for use with the microphone and transmitter described above may optionally include a digital decimating low pass filter. Before transmission, the modulated signal is also preferably encoded using an error correction code such as a forward error correcting code (e.g., a convolutional code). One of the novel characteristics of this invention arises from an enhanced system robustness and error resistance noted when a convolutional error correcting code is implemented. This robustness is attributed to the relative unimportance of bit weighting when using low bit-weight words. Preferably, the oversampled, low bit-weight word sequences are also interleaved or shuffled to mitigate potential error bursts and are then transmitted on an RF carrier signal using digital modulation methods to provide robust receiver system performance. Preferably, the system radiates in one of the unlicensed bands such as the 2,400 Megahertz (MHz) or 5,800 MHz bands. Optionally, a return channel from the receiver system to each transmitter may be included to permit adaptive power control of each microphone/transmitter system in order to minimize transmitter power consumption and inter-transmitter interference. A system optionally includes an analog signal source such as a microphone, a converter to digitize that analog signal and generate low bit-weight digital words, a transmitter (all incorporated into a microphone/transmitter assembly preferably enclosed in a housing), as well as a receiver. Preferably, the microphone/transmitter assembly has small size and small power consumption. The system includes the fewest number of complex, power consuming components within the microphone/transmitter assembly, thereby shifting the signal processing burden onto the receiver that will not face stringent requirements for small size or small power consumption.

Having described preferred embodiments of a new and improved method, it is believed that other modifications, variations and changes will be suggested to those skilled in the art in view of the teachings set forth herein. It is therefore to be understood that all such variations, modifications and changes are believed to fall within the scope of the present invention as defined by the appended claims.

What is claimed is:

1. A wireless audio signal transmission system, comprising:
an analog signal source generating an analog audio signal of a desired audio bandwidth;
an analog signal sampling circuit responsive to said analog audio signal and generating a sequence of low bit weight digital words, wherein said low bit weight words comprise binary words having four or fewer bits per word;
wherein said sampling circuit samples said audio signal at a sampling frequency substantially greater than twice the highest frequency for said desired bandwidth of said audio signal;
a data encoder responsive to said series of low bit weight words, wherein said data encoder encodes said series of low bit weight words into an error control coded digital signal; and
a digital modulator responsive to said error control coded digital signal, wherein said digital modulator generates a representation of a desired RF signal for transmission to a receiver.

2. The wireless audio signal transmission system of claim 1, wherein said analog signal sampling circuit generates a sequence of low bit weight digital words having one bit per word.

3. The wireless audio signal transmission system of claim 1, wherein said sampling circuit samples said audio signal at a sampling frequency substantially greater than forty thousand times per second.

4. The wireless audio signal transmission system of claim 1, wherein said sampling circuit samples said audio signal at a sampling frequency substantially greater than eighty thousand times per second.

5. The wireless audio signal transmission system of claim 1, wherein said analog signal sampling circuit comprises a delta-sigma modulator responsive to said analog audio signal modulating said audio signal into a series of low bit weight words.

6. The wireless audio signal transmission system of claim 1, wherein said digital modulator generates a first representation of a desired RF signal as an in-phase analog signal and generates a second representation of a desired RF signal as a quadrature analog signal, and
said wireless audio signal transmission system further including an IQ modulator having a first input responsive to said in-phase analog signal and said IQ modulator having a second input responsive to said quadrature analog signal to generate an RF signal.

7. The wireless audio signal transmission system of claim 1, wherein said encoder comprises:
a scrambler responsive to said series of low bit weight words generating, through binary addition with a deterministic sequence of ones and zeros, a randomized sequence;
a forward error control encoder responsive to said randomized sequence to generate a plurality of coded output bits for each randomized sequence input bit; and
an interleaver responsive to said plurality of coded output bits and generating a shuffled sequence comprising said error control coded digital signal.

8. The wireless audio signal transmission system of claim 7, wherein said interleaver has a length of less than one millisecond when the data transmitted is transmitted at approximately one megabit per second.

9. The wireless audio signal transmission system of claim 7, wherein said. forward error control encoder generates said plurality of coded output bits in multi-bit parallel words which are then input to a parallel to serial converter.

10. The wireless audio signal transmission system of claim 1, wherein said digital modulator generates an RF signal in an unlicensed frequency band.

11. The wireless audio signal transmission system of claim 10, wherein said modulator generates an RF signal in the unlicensed frequency band in the frequency range of 902 MHz through 928 MHz.

12. The wireless audio signal transmission system of claim 10, wherein said modulator generates an RF signal in the unlicensed frequency band in the frequency range of 2400 MHz through 2483.5 MHz.

13. The wireless audio signal transmission system of claim 10, wherein said modulator generates an RF signal in the unlicensed frequency band in the frequency range of 5725 MHz through 5850 MHz.

14. The wireless audio signal transmission system of claim 1, wherein said analog signal source comprises a transducer.

15. The wireless audio signal transmission system of claim 14, wherein said transducer comprises a microphone.

16. The wireless audio signal transmission system of claim 15, further including:
an antenna responsive to said desired RF signal; and
a housing adapted to support said microphone, said delta-sigma modulator, said data encoder, said digital modulator and said antenna.

17. A method for transmitting a Radio Frequency (RF) signal corresponding to an analog audio or acoustic signal, comprising the method steps of:
(a) converting an analog audio or acoustic signal into a low bit weight digital signal comprising four or fewer bits per word;
(b) encoding said low bit weight digital signal with an error correction code to provide an encoded low bit weight digital signal;
(c) modulating an RF carrier signal with said encoded low bit weight digital signal to generate an encoded low-bit weight digital transmission signal; and
(d) transmitting said encoded low-bit weight digital transmission signal.

18. The method of claim 17, wherein converting step (a) comprises converting said analog audio or acoustic signal into a low bit weight digital signal by a delta sigma modulation method.

19. The method of claim 17, wherein converting step (a) comprises converting said analog audio or acoustic signal into a low bit weight digital signal having one bit per digital word.

20. The method of claim 17, wherein encoding step (b) comprises encoding said low bit weight digital signal with a convolutional error correction code to generate a data stream and then processing said data stream using bit interleaving methods to provide an encoded low bit weight digital signal.

21. The method of claim 17, wherein modulating step (c) comprises modulating an RF carrier signal with said encoded low bit weight digital signal using QAM quadrature amplitude digital modulation methods to generate an encoded low-bit weight digital transmission signal.

22. The method of claim 17, wherein modulating step (c) comprises modulating an RF carrier signal with said encoded low bit weight digital signal using QPSK quadrature phase shift keying digital modulation methods to generate an encoded low-bit weight digital transmission signal.

23. A wireless audio signal transmission system receiver, comprising:
(a) a demodulator responsive a digitally modulated RF signal and configured to generate a digital low bit weight digital signal; and
(b) a digital decimating low pass filter responsive to said digital low bit weight digital signal and configured to generate a pulse code modulation digital audio signal.

24. The wireless audio signal transmission system receiver of claim 23, further comprising:
(c) a digital to analog converter responsive to said digital filtered signal and configured to generate an analog audio signal.

25. The wireless audio signal transmission system receiver of claim 21, further comprising:
(c) a power sensing circuit responsive to said digitally modulated RF signal and configured to generate a received power level signal in response thereto.

26. The wireless audio signal transmission system receiver of claim 23, further comprising:
(c) a power level feedback signal transmitter responsive to said received power level signal and configured to transmit a power level feedback signal to a transmitter transmitting said digitally modulated RF signal.

27. A wireless audio signal transmission system, comprising:
an analog signal source generating an analog audio signal of a desired audio bandwidth;
an analog signal sampling circuit responsive to said analog audio signal and generating a series of low bit weight words, wherein said low bit weight words comprise binary words having four or fewer bits per word;
wherein said sampling circuit samples said audio signal at a sampling frequency substantially greater than twice the highest frequency for said bandwidth of said audio signal;
a data encoder responsive to said series of low bit weight words, wherein said data encoder encodes said series of low bit weight words into an error control coded digital signal;
a digital modulator responsive to said error control coded digital signal, wherein said digital modulator generates a representation of a desired RF signal for transmission to a receiver; and
a receiver including a demodulator responsive to said RF signal and configured to generate a digital low bit weight digital signal.

28. The wireless audio signal transmission system of claim 27, wherein said receiver includes a digital decimating low pass filter responsive to said digital low bit weight digital signal and configured to generate a pulse code modulation digital audio signal.

29. The wireless audio signal transmission system of claim 27, further comprising a digital to analog converter responsive to said digital filtered signal and configured to generate an analog audio signal.

30. The wireless audio signal transmission system of claim 27, further comprising a power sensing circuit responsive to said received RF signal and configured to generate a received power level signal in response thereto.

31. The wireless audio signal transmission system of claim 30, further comprising a power level feedback signal transmitter responsive to said received power level signal and configured to transmit a power level feedback signal to said transmitter, wherein said transmitter adjusts amplitude of said transmitted signal in response to said power level feedback signal.

32. The wireless audio signal transmission system of claim 27, further comprising a second receiver including a second demodulator responsive to said RF signal and configured to generate a second digital low bit weight digital signal.

33. A wireless audio signal transmission system, comprising:
an analog signal source generating an analog audio signal of a desired audio bandwidth;
an analog signal sampling circuit responsive to said analog audio signal and generating a sequence of low bit weight digital words, wherein said low bit weight words comprise binary words having four or fewer bits per word;
wherein said sampling circuit samples said audio signal at a sampling frequency of substantially 2.8224 megahertz;
a data encoder responsive to said series of low bit weight words, wherein said data encoder encodes said series of low bit weight words into an error control coded digital signal; and
a digital modulator responsive to said error control coded digital signal, wherein said digital modulator generates a representation of a desired RF signal for transmission to a receiver.
